(19) United States
(12) Patent Application Publication
(10) Pub. No.: US 2016/0307389 A1
(43) Pub. Date: Oct. 20, 2016

(54) MEDIUM PROCESSING APPARATUS

(71) Applicant: NAUTILUS HYOSUNG INC., Seoul (KR)

(72) Inventors: Jae Hoon KWAK, Gyeonggi-do (KR); Chang Ho PARK, Gyeonggi-do (KR); Jin Hwan CHA, Gyeonggi-do (KR); Jin Yong HWANG, Gyeonggi-do (KR)

(21) Appl. No.: 15/100,403

(22) PCT Filed: Nov. 19, 2014
(86) PCT No.: PCT/KR2014/011093

§ 371 Date: May 31, 2016

(30) Foreign Application Priority Data
Nov. 29, 2013 (KR) 10-2013-0147348

(51) Int. Cl. G07D 11/00; G07F 19/00

(52) U.S. Cl. CPC G07D 11/0021; G07D 11/0081; G07F 19/202; G07F 19/203

(57) ABSTRACT

The purpose of the present invention is to provide a medium processing apparatus capable of efficiently processing a medium by shortening the length of a check returning path by spatially separately forming spaces for storing checks and banknotes in the medium processing apparatus. To this end, the medium processing apparatus of the present invention comprises: a deposit and withdrawal unit (100) having a space for inserting or receiving a medium when making a deposit or withdrawal; a discrimination unit (200) for discriminating whether or not there is an abnormality in the medium and discriminating the denomination of the medium; a temporary storage unit (300) for temporarily storing the medium which has passed through the discrimination unit (200); a check storage unit (400) for containing checks; a banknote storage unit (600) consisting of a plurality of cassettes (610, 620, 630, 640, 650, 660) for containing banknotes; a rejected medium storage unit (800) for containing a medium rejected by the discrimination unit (200); and a returning path (900) for returning the medium, wherein the deposit and withdrawal unit (100), the discrimination unit (200), the temporary storage unit (300) and the check storage unit (400) are formed in an upper module (1), and the banknote storage unit (600) is formed in a lower module (2) installed in the bottom of the upper module (1).

### TECHNICAL FIELD

The present disclosure relates to a medium processing apparatus disposed in an automated teller machine (ATM) to process a banknote and a check together, and more particularly, to a medium processing apparatus capable of simultaneously shortening a length of a check returning path to be deposited and promptly and efficiently performing a deposit or a withdrawal of a banknote.

### BACKGROUND ART

Generally, a medium processing apparatus for processing media such as a banknote or a check to be deposited or withdrawn is disposed in an automated teller machine (ATM).

FIG. 1 is a block diagram of a conventional medium processing apparatus.

The conventional medium processing apparatus includes a deposit and withdrawal unit 10 having a medium dispensing mechanism 11 and a medium storing mechanism 12 formed of a plurality of rollers for a user to insert or receive a medium for depositing or withdrawing the medium, a discrimination unit 20 to discriminate an abnormality and a denomination of a medium being deposited or withdrawn through the deposit and withdrawal unit 10, a banknote temporary storage unit 30 to temporarily store a banknote that has been identified as a normal medium by the discrimination unit 20 among media deposited through the deposit and withdrawal unit 10, a check temporary storage unit 40 to temporarily store a check that has been identified as a normal medium by the discrimination unit 20 among media deposited through the deposit and withdrawal unit 10, a typing unit 41 to print deposit confirmation information (financial information) about a deposited check, a banknote storage unit 50 formed of a plurality of cassettes to carry out a banknote stored inside when a deposited banknote is stored and there is a request for a withdrawal, a check storage unit 60 to store a deposited check, a rejected medium storage unit 70 to which a medium identified as being abnormal by the discrimination unit 20 among banknotes and checks withdrawn from the banknote storage unit 50 and the check storage unit 60 is returned, a returning path 80 through which a medium is returned, and a safe 90 in which the banknote storage unit 50, the check storage unit 60, and the rejected medium storage unit 70 are stored.

Since the banknote temporary storage unit 30 and the check temporary storage unit 40 are separated in the conventional medium processing apparatus, a large space inside the medium processing apparatus is occupied for installing the banknote temporary storage unit 30 and the check temporary storage unit 40, and there is a disadvantage of inconvenience in miniaturizing and lightening the medium processing apparatus.

In addition, since the banknote storage unit 50 and the check storage unit 60 are installed together at a lower portion of the medium processing apparatus in the conventional medium processing apparatus, a path of returning from the deposit and withdrawal unit 10 to the banknote storage unit 50 and the check storage unit 60 is lengthened, and the banknote storage unit 50 and the check storage unit 60 are formed in a structure of sharing the returning path 80 for returning a banknote and a check. Thus, there is a disadvantage of having a limit in promptly processing a banknote and a check from the deposit and withdrawal unit 10 to the banknote storage unit 50 and the check storage unit 60.

In addition, since the returning path 80 that passes through the discrimination unit 20 to be connected to the banknote storage unit 50, the check storage unit 60, and the rejected medium storage unit 70 is formed in a structure of being connected only to one side with respect to the discrimination unit 20 in the conventional medium processing apparatus, in order to prevent interference between a banknote and a check returned in a process of depositing or withdrawing a medium, a standby time in which an operation of processing a remaining medium is stopped while any one of the banknote and the check is being processed is lengthened, and there is a problem of difficulty in smoothly processing media.

Meanwhile, a durable structure capable withstanding an unauthorized external intrusion for a predetermined amount of time or longer is required for the safe 90 in order to safely keep media stored in the banknote storage unit 50, the check storage unit 60, and the rejected medium storage unit 70. For this, the safe 90 is manufactured by coupling a reinforced structure formed of a piece of steel between an inner plate and an outer plate formed of steel, mixing concrete with a filler such as reinforcing fibers, and pouring and curing the concrete.

When the safe 90 formed as the above structure is installed within a medium processing apparatus, a volume of the medium processing apparatus is also enlarged proportional to a space occupied by the safe 90, a weight of the medium processing apparatus also increases due to a weight of the safe 90 formed of steel and concrete, and the cost of manufacturing the safe increases. Consequently, in order to miniaturize and lighten the medium processing apparatus, the safe 90 installed therein should be miniaturized and lightened.

Meanwhile, among the checks stored in the check storage unit 60, deposited checks are not reusable anymore due to deposit confirmation information printed in the typing unit 41, and withdrawn checks are not distributable when in a state before withdrawal confirmation information is printed in a typing unit (not shown).

Consequently, in a case of a check stored in the check storage unit 60, there is no possibility for the check to be distributed even when theft occurs due to an external intrusion. However, because the banknote storage unit 50 as well as the check storage unit 60 are installed inside the safe 90 in the conventional medium processing apparatus, there is a problem in which the sizes and the weights of the safe 90 and the medium processing apparatus including the same are enlarged and increased.

### DISCLOSURE

### Technical Problem

The present disclosure has been devised to solve the above problems and is directed to providing a medium processing apparatus configured by spatially separating spaces in which checks and banknotes are stored to be at an upper portion and a lower portion of the medium processing apparatus, thereby shortening a length of a returning path of the checks and enabling media to be efficiently processed.

Another aspect of the present disclosure is to provide a medium processing apparatus in which a structure of a returning path is simplified to enable a medium to be smoothly processed and space utilization inside the medium processing apparatus to be improved.

Still another aspect of the present disclosure is to provide a medium processing apparatus having a cassette arrangement structure of a banknote storage unit capable of efficiently processing a medium.

Still another aspect of the present disclosure is to provide a medium processing apparatus capable of miniaturizing and lightening a size and a weight of a safe installed at the medium storage apparatus in order to prevent theft of banknotes.

### Technical Solution

In order to achieve the aspects mentioned above, a medium processing apparatus of the present disclosure for processing media consisting of banknotes and checks to be deposited or withdrawn includes a deposit and withdrawal unit 100 having a space for inserting or receiving the media when the media are being deposited or withdrawn, a discrimination unit 200 to discriminate an abnormality and a denomination of the media, a temporary storage unit 300 in which media that have passed through the discrimination unit 200 are temporarily stored, a check storage unit 400 to store the checks, a banknote storage unit 600 formed of a plurality of cassettes 610, 620, 630, 640, 650, and 660 to store the banknotes, a rejected medium storage unit 800 in which media rejected by the discrimination unit 200 are stored, and a returning path 900 to return the media, wherein the deposit and withdrawal unit 100, the discrimination unit 200, the temporary storage unit 300, and the check storage unit 400 are disposed in an upper module 1, and the banknote storage unit 600 is disposed in a lower module 2 installed below the upper module 1.

A returning path configured to connect the deposit and withdrawal unit (100) to the check storage unit (400) is disposed in the upper module (1) and a returning path configured to connect the deposit and withdrawal unit (100) to the banknote storage unit (600) may be disposed across the upper module (1) and the lower module (2).

A first connected returning path connected to the banknote storage unit (600) across the upper module (1) and the lower module (2) is disposed at an inlet side of the discrimination unit (200) and a second connected returning path connected to the first connected returning path across the upper module (1) and the lower module (2) may be disposed at an outlet side of the discrimination unit (200).

The returning path (900) may include a first returning path (901) configured to connect the deposit space (110) of the deposit and withdrawal unit (100) to an inlet of the discrimination unit (200); a second returning path (902) configured to connect an outlet of the discrimination unit (200) to the withdrawal space (120) of the deposit and withdrawal unit (100); a third returning path (903) branched from the second returning path (902) to be connected to the temporary storage unit (300); a fourth returning path (904) branched from the second returning path (902) to be connected to the check storage unit (400); a sixth returning path (906) branched from the first returning path (901) disposed at the inlet side of the discrimination unit (200) to form the first connected returning path; and a seventh returning path (907) branched from the second returning path (902) disposed at the outlet side of the discrimination unit (200) to form the second connected returning path.

The plurality of cassettes (610, 620,630, 640, 650, 660) include cassettes (610, 620, 630) of a same height installed in parallel in a transverse direction, a fifth cassette (650) and a sixth cassette (660) formed at a lower height than those of the cassettes (610, 620, 630) and installed in a vertically stacked structure, and a fourth cassette (640) installed between the cassettes (610, 620, 630) of the same height and the fifth cassette (650) and the sixth cassette (660) while being installed to be spaced apart from the fifth cassette (650) and the sixth cassette (660); the rejected medium storage unit (800) is installed at one side of the fifth cassette (650) and the sixth cassette (660); the sixth returning path (906) is connected to the cassettes (610, 620, 630) of the same height, the fourth cassette (640), and the rejected medium storage unit (800); and in a gap between the fourth cassette (640) and the fifth cassette (650) and the sixth cassette (660), an eighth returning path (908) branched from the sixth returning path (906) to be connected to the fifth cassette (650) and a ninth returning path (909) branched from the eighth returning path (908) to be connected to the sixth cassette (660) may be installed.

One end of the seventh returning path (907) is connected to the second returning path (902) disposed at the outlet side of the discrimination unit (200); the other end of the seventh returning path (907) is connected to the sixth returning path (906) at a point spaced apart toward a rear at a branching point at which the sixth returning path (906) and the eighth returning path 908 are connected; and interference between banknotes returned through the eighth returning path (908) and the sixth returning path (906) and banknotes returned through the seventh returning path (907) and the sixth returning path (906) is prevented.

When banknotes loaded into the banknote storage unit (600) are being withdrawn: banknotes dispensed from the cassettes (610, 620, 630) of the same height and the fourth cassette (640) are returned to the discrimination unit (200) along the sixth returning path (906) and the first returning path (901), and banknotes dispensed from the fifth cassette (650) are returned to the discrimination unit (200) along the eighth returning path (908), the sixth returning path (906) and the first returning path (901); and banknotes identified as rejected media by the discrimination unit (200) are returned to the rejected medium storage unit (800) along the second returning path (902), the seventh returning path (907), and the sixth returning path (906).

A lost/returned medium storage unit (500) is disposed in a vertically stacked structure with the check storage unit (400) in the upper module (1); and the returning path (900) further may include a fifth returning path (905) connecting from the second returning path (902) to a side of the lost/returned medium storage unit (500) to return media dispensed from the temporary storage unit (300) to the lost/returned medium storage unit (500).

A lost/returned medium storage unit (500) is disposed in a vertically stacked structure with the check storage unit (400) in the upper module (1); the returning path (900) includes a tenth returning path (910) branched at a branching point (G2) at which the second returning path (902) and the seventh returning path (907) are branched in a direction parallel to the second returning path (902) disposed at the outlet side of the discrimination unit (200) and connected to a side of the lost/returned medium storage unit (500); and at the branching point (G2), a direction-switching gate for switching a returning path of media in any one direction of the second returning path (902), the seventh returning path (907), and the tenth returning path (910) may be disposed.

The banknote storage unit (600) and the rejected medium storage unit (800) may be disposed inside a safe (1000), and the check storage unit (400) may be disposed outside the safe (1000).

An add/return cassette (660b) for adding or returning banknotes may be included in the banknote storage unit (600); and when banknotes in the add/return cassette (660b) are added to remaining cassettes (610, 620, 630, 640, 650) of the banknote storage unit 600 or when banknotes in the remaining cassettes (610, 620, 630, 640, 650) are returned to the add/return cassette (660b), the banknotes may pass through the temporary storage unit (300).

When banknotes are added to the remaining cassettes (610, 620, 630, 640, 650), banknotes dispensed from the add/return cassette (660b) may pass through the discrimination unit (200) and are then returned to the temporary storage unit (300); banknotes identified as normal media by the discrimination unit (200) are dispensed from the temporary storage unit (300), pass through the discrimination unit (200), and are then returned to the remaining cassettes (610, 620, 630, 640, 650); and banknotes identified as rejected media by the discrimination unit (200) are dispensed from the temporary storage unit (300), may pass through the discrimination unit (200), and are then returned to the rejected medium storage unit (800).

The returning path (900) may include a first returning path (901) configured to connect the deposit space (110) of the deposit and withdrawal unit (100) to an inlet of the discrimination unit (200), a second returning path (902) configured to connect an outlet of the discrimination unit (200) to the withdrawal space (120) of the deposit and withdrawal unit (100), a third returning path (903) branched from the second returning path (902) to be connected to the temporary storage unit (300), a fourth returning path (904) branched from the second returning path (902) to be connected to the check storage unit (400), a sixth returning path (906) branched from the first returning path (901) disposed at an inlet side of the discrimination unit (200) across the upper module (1) and the lower module (2) to form a first connected returning path connected to the banknote storage unit (600), and a seventh returning path (907) branched from the second returning path (902) disposed at an outlet side of the discrimination unit (200) across the upper module (1) and the lower module (2) to form a second connected returning path connected to the first connected returning path; banknotes identified as normal media by the discrimination unit (200) are dispensed from the temporary storage unit (300), pass through the discrimination unit (200) along the third returning path (903) and the second returning path (902), and are then returned to the remaining cassettes (610, 620, 630, 640, 650) along the first returning path (901) and the sixth returning path (906); and banknotes identified as rejected media by the discrimination unit (200) are dispensed from the temporary storage unit (300), pass through the discrimination unit (200) along the third returning path (903) and the second returning path (902), and are then returned to the rejected medium storage unit (800) along the first returning path (901) and the sixth returning path (906).

When banknotes loaded into the remaining cassettes (610, 620, 630, 640, 650) are being returned: banknotes dispensed from the remaining cassettes (610, 620, 630, 640, 650) may pass through the discrimination unit (200) and are then returned to the temporary storage unit (300); banknotes identified as normal media by the discrimination unit (200) are dispensed from the temporary storage unit (300), may pass through the discrimination unit (200), and are then returned to the add/return cassette (660b); and banknotes identified as rejected media by the discrimination unit (200) are dispensed from the temporary storage unit (300), may pass through the discrimination unit (200), and are then returned to the rejected medium storage unit (800).

The remaining cassettes (610, 620,630, 640, 650) may include cassettes (610, 620, 630) of a same height installed in parallel in a transverse direction, a fifth cassette (650) and a sixth cassette (660) formed at a lower height than those of the cassettes (610, 620, 630) and installed in a vertically stacked structure, and a fourth cassette (640) installed between the cassettes (610, 620, 630) of the same height and the fifth cassette (650) and the sixth cassette (660) while being installed to be spaced apart from the fifth cassette (650) and the sixth cassette (660); the returning path (900) may include a first returning path (901) configured to connect the deposit space (110) of the deposit and withdrawal unit (100) to an inlet of the discrimination unit (200), a second returning path (902) configured to connect an outlet of the discrimination unit (200) to the withdrawal space (120) of the deposit and withdrawal unit (100), a third returning path (903) branched from the second returning path (902) to be connected to the temporary storage unit (300), a fourth returning path (904) branched from the second returning path (902) to be connected to the check storage unit (400), a sixth returning path (906) branched from the first returning path (901) disposed at the inlet side of the discrimination unit (200) across the upper module (1) and the lower module (2) to form a first connected returning path connected to the banknote storage unit (600), a seventh returning path (907) branched from the second returning path (902) disposed at the outlet side of the discrimination unit (200) across the upper module (1) and the lower module (2) to form a second connected returning path connected to the first connected returning path, an eighth returning path (908) branched from the sixth returning path (906) to be connected to the fifth cassette (650), and a ninth returning path (909) branched from the eighth returning path (908) to be connected to the sixth cassette (660); banknotes dispensed from the cassettes (610, 620, 630) of the same height and the fourth cassette (640) are returned to the discrimination unit (200) along the sixth returning path (906) and the first returning path (901), banknotes dispensed from the fifth cassette (650) are returned to the discrimination unit (200) along the eighth returning path (908), the sixth returning path (906) and the first returning path (901), and banknotes that have passed through the discrimination unit (200) are returned to the temporary storage unit (300) along the second returning path (902) and the third returning path (903); banknotes identified as normal media by the discrimination unit (200) are dispensed from the temporary storage unit (300), pass through the discrimination unit (200) along the third returning path (903) and the second returning path (902), and are then returned to the add/return cassette (660b) along the first returning path (901), the sixth returning path (906), the eighth returning path (908), and the ninth returning path (909); and banknotes identified as rejected media by the discrimination unit (200) are dispensed from the temporary storage unit (300), pass through the discrimination unit (200) along the third returning path (903) and the second returning path (902), and are then returned to the rejected medium storage unit (800) along the first returning path (901) and the sixth returning path (906).

A sixth cassette (660) is formed with any one of a depositing/withdrawing cassette (660a) in which banknotes to be deposited or withdrawn are stored or an add/return cassette (660b) for adding or returning banknotes to the banknote storage unit (600), and the depositing/withdrawing cassette (660a) and the add/return cassette (660b) may be replaceably installed.

### Advantageous Effects

By installing a check storage unit in an upper module of a medium processing apparatus and installing a plurality of cassettes that form a banknote storage unit in a lower module in order to spatially separate spaces in which checks and banknotes are stored to be at an upper portion and a lower portion of the medium processing apparatus, a length of a returning path through which the checks are returned may be shortened and interference with a returning path through which the banknotes are returned may be prevented, thereby enabling efficient processing of the media.

In addition, by configuring the upper module and the lower module to be connected via a first connected returning path and a second connected returning path installed at an inlet side and an outlet side of a discrimination unit, the banknotes can be promptly processed to be returned.

In addition, by configuring the plurality of cassettes that form the banknote storage unit in various sizes and arranging small-sized cassettes in a vertically stacked structure, when denominations of banknotes being dealt with are different, the banknotes may be separated and stored for each type of denomination, and the cassettes may be efficiently managed by being separated for each type of media according to a frequency of use.

In addition, by installing a safe in which the banknote storage unit and a rejected medium storage unit are stored in the lower module and installing the check storage unit in the upper module, a wide space for storing banknotes may be secured inside the safe.

### DESCRIPTION OF DRAWINGS

FIG. 1 is a block diagram of a conventional medium processing apparatus.

FIG. 2 is a block diagram of a medium processing apparatus according to a first embodiment of the present disclosure.

FIG. 3 is an operational state diagram illustrating a returning path of media which are normal media when the media are being deposited and counted in the medium processing apparatus according to the first embodiment of the present disclosure.

FIG. 4 is an operational state diagram illustrating a returning path of banknotes which are normal media when the banknotes are being deposited and stored in the medium processing apparatus according to the first embodiment of the present disclosure.

FIG. 5 is an operational state diagram illustrating a returning path of checks which are normal media when the checks are being deposited and stored in the medium processing apparatus according to the first embodiment of the present disclosure.

FIG. 6 is an operational state diagram illustrating a returning path of banknotes which are normal media when the banknotes are being withdrawn from the medium processing apparatus according to the first embodiment of the present disclosure.

FIG. 7 is an operational state diagram illustrating a returning path of banknotes which are rejected media when the banknotes are being withdrawn from the medium processing apparatus according to the first embodiment of the present disclosure.

FIG. 8 is an operational state diagram illustrating a returning path of banknotes when lost banknotes are being returned to the medium processing apparatus according to the first embodiment of the present disclosure.

FIG. 9 is an operational state diagram illustrating a returning path of banknotes which are normal media when the banknotes are being added into the medium processing apparatus according to the first embodiment of the present disclosure.

FIG. 10 is an operational state diagram illustrating a returning path of banknotes which are rejected media when the banknotes are being added into the medium processing apparatus according to the first embodiment of the present disclosure.

FIG. 11 is an operational state diagram illustrating a returning path of banknotes which are normal media when the banknotes are being returned to the medium processing apparatus according to the first embodiment of the present disclosure.

FIG. 12 is an operational state diagram illustrating a returning path of banknotes which are rejected media when the banknotes are being returned to the medium processing apparatus according to the first embodiment of the present disclosure.

FIG. 13 is an operational state diagram illustrating a returning path of media when lost media are being returned to a medium processing apparatus according to a second embodiment of the present disclosure.

FIG. 14 is a block diagram of a medium processing apparatus according to a third embodiment of the present disclosure.

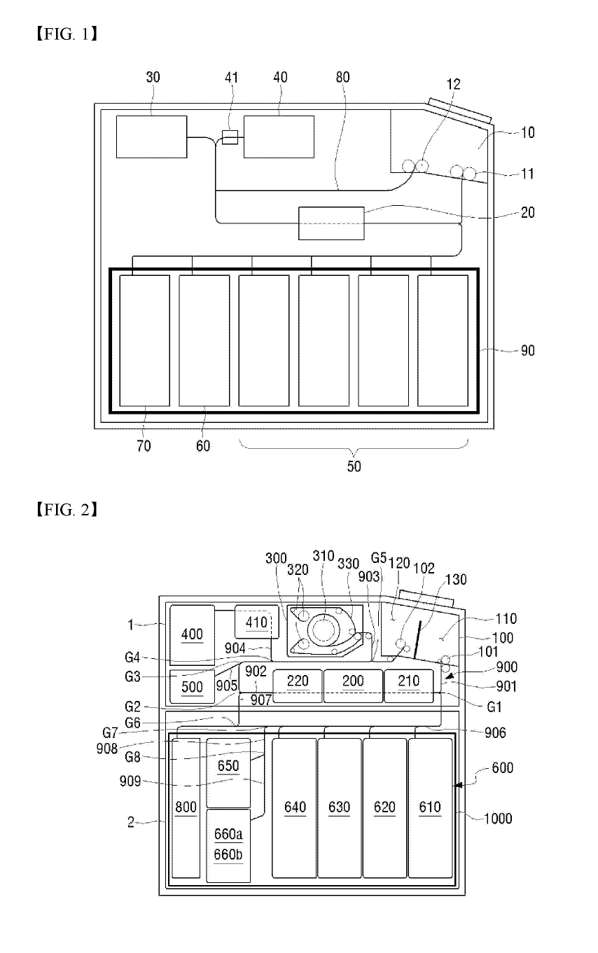

### MODES OF THE INVENTION

Hereinafter, configurations and actions of preferred embodiments of the present disclosure will be described in detail below with reference to the accompanying drawings. Hereinafter, in describing a direction in the present specification, “front” is used to refer to a direction facing rightward in the drawings, and “rear” is used to refer to a direction facing leftward in the drawings. In addition, it is clarified here that “media storage cassette” is used to collectively refer to first to sixth cassettes 610, 620, 630, 640, 650, and 660, a depositing/withdrawing cassette 660a, an add/return cassette 660b, and a rejected medium storage unit 800 disposed in a lower module 2.

FIG. 2 is a block diagram of a medium processing apparatus according to a first embodiment of the present disclosure.

The medium processing apparatus according to the first embodiment of the present disclosure includes a deposit and withdrawal unit 100 in which insertion and reception of media occur when the media are being deposited and withdrawn, a discrimination unit 200 to discriminate an abnormality and a denomination of the media, a temporary storage unit 300 in which media that have passed through the discrimination unit 200 are temporarily stored, a typing unit 410 to type (print) deposit confirmation information on checks identified as normal media among the media that have passed through the discrimination unit 200, a check storage unit 400 to store checks on which the deposit confirmation information is typed, a lost/returned medium storage unit 500 into which banknotes that are not taken from the deposit and withdrawal unit 100 after the banknotes are withdrawn are returned and stored, a banknote storage unit 600 formed of a plurality of cassettes to return the banknotes stored therein when deposited banknotes are stored and there is a request for a withdrawal, the rejected medium storage unit 800 in which media identified as being abnormal by the discrimination unit 200 among the banknotes withdrawn from the banknote storage unit 600 are stored, a returning path 900 through which media is returned between elements of the medium processing apparatus, and a safe 1000 in which the banknote storage unit 600 and the rejected medium storage unit 800 are stored.

The medium processing apparatus is formed of an upper module 1 and a lower module 2. The deposit and withdrawal unit 100, the discrimination unit 200, the temporary storage unit 300, the check storage unit 400, and the lost/returned medium storage unit 500 are disposed in the upper module 1, and the banknote storage unit 600, the rejected medium storage unit 800, and the safe 1000 that surrounds the above and maintains security are installed in the lower module 2.

In this manner, due to the check storage unit 400 being disposed in the upper module 1 and the banknote storage unit 600 being disposed in the lower module 2, when checks and banknotes are inserted together through the deposit and withdrawal unit 100 and a depositing process is performed, the checks are configured to be processed to be deposited and stored, cancelled from being deposited, or rejected from being deposited along a returning path disposed inside the upper module 1. Thus, a returning path of checks is configured to be short and an installation structure of the returning path is simplified. Furthermore, when processing the banknotes, a returning path of the banknotes is separated from the returning path of the checks, thereby enabling the banknotes to be processed promptly and smoothly.

In addition, by the safe 1000 being installed in the lower module 2 and the check storage unit 400 being installed in the upper module 1 placed outside the safe 1000, the medium processing apparatus is formed in a structure in which a wide space for storing banknotes may be secured inside the safe 1000.

Hereinafter, each element of the medium processing apparatus according to the embodiment will be described.

The deposit and withdrawal unit 100 is formed of a deposit space 110 in which media are inserted and loaded thereinto when the media are being deposited, and a withdrawal space 120 spatially separated from the deposit space 110 by a movable plate 130 and having media loaded thereinto when the media are withdrawn.

The deposit space 110 is a space into which a user inserts media when depositing the media. A medium dispensing mechanism 101 that separates each sheet of the media loaded into the deposit space 110 to dispense each of the sheets of the media toward a returning path 901 is disposed at a lower portion of the deposit space 110. The medium dispensing mechanism 101 may be formed of a pickup roller to separate each of the sheets of the media, a feed roller to apply a feed force to each of the sheets of the media separated by the pickup roller, and a guide roller installed to face the feed roller in order to prevent two sheets of the media from being separated at once.

The plate 130 may be formed of two or more plates and is formed to be movable back and forth by a driver (not shown).

When the media are being processed to be deposited, the plate 130 is moved toward the deposit space 110 by the driver to press the media, the media is made to come in contact with the pickup roller of the medium dispensing mechanism 101, each of the sheets of the media is separated by the pickup roller, and each of the sheets of the media are returned through the returning path 901 by the feed roller and the guide roller.

The withdrawal space 120 is a space in which media dispensed from the banknote storage unit 600 and returned when banknotes are withdrawn are loaded or media identified as rejected media when the media are deposited are loaded. A medium storing mechanism 102 formed of a plurality of rollers to apply a feed force to the media in order to load the media inside the withdrawal space 120 is disposed at a lower portion of the withdrawal space 120.

When the media are stored inside the withdrawal space 120 by the medium storing mechanism 102, the plate 130 may be moved toward the deposit space 110 by the driver and the media stored in the withdrawal space 120 may be moved up to a location of the deposit space 110 to enable a user to receive the media.

The discrimination unit 200 identifies an abnormality and a denomination of a medium returned along a returning path 902. The discrimination unit 200 includes a returning path in which media are returned, a driving mechanism driven to enable two-way returning of media is disposed in the returning path, and the discrimination unit 200 is configured to be able to discriminate the media regardless of a returning direction when the two-way returning of media occurs.

Detectors such as a length detection sensor, an image sensor, and a two-sheet detection unit are included inside the discrimination unit 200 such that, while a length of a medium passing through the returning path 902 is detected, an image of the medium is scanned to discriminate whether the medium being returned is a check or a banknote, information such as an identification number and sum information of a corresponding check is transmitted to a control unit (not shown) when the medium being returned is a check, and when the medium being returned is a banknote, genuineness, denomination, and damage of the banknote are identified and the results are transmitted to the control unit.

The control unit discriminates whether the corresponding check is normal based on the information such as the identification number and the sum information of the check transmitted from the discrimination unit 200.

In order for the discrimination unit 200 to detect accurate information on a medium, the medium being returned along the returning path 902 should be arranged to be parallel to a returning direction of the returning path 902. That is, since a position at which the medium is detected becomes different from a set position when the medium being returned is returned in a state of being skewed to one side with respect to the returning direction of the returning path 902, a length and an image of the medium, and whether the medium is formed of two sheets cannot be accurately detected.

In addition, in order to prevent a jam of media when the media that have passed through the discrimination unit 200 are returned, the media should be returned while being positioned at a middle portion of the returning path 902 in the width direction.

For the above, the discrimination unit 200 includes a skew correcting unit 210 to correct an angle of a medium being returned to be within a set angle range (e.g. a range of 15° from both sides with respect to the returning direction) and an alignment correcting unit 220 to correct an eccentric position of a medium to be a regular position so that the medium is positioned at the middle portion of the returning path in the width direction.

The skew correcting unit 210 may be configured to correct a medium skewed to one side to be disposed parallel to the returning direction by varying rotational speeds of return rollers (not shown) that support both ends of the medium. The alignment correcting unit 220 may be configured to include mechanisms (not shown) coming in contact with the both ends of the medium being returned to correct a position of the medium eccentric in the width direction to be the regular position or may be installed such that front end portions of the return rollers (not shown) that support the both ends of the medium are skewed in a direction facing the middle portion of the returning path in the width direction based on the returning direction in order to correct the position of the medium that has become eccentric in a process of returning the medium to be the regular position.

Based on a returning path of a medium being deposited, the discrimination unit 200, the skew correcting unit 210, and the alignment correcting unit 220 may be arranged in an order of the skew correcting unit 210, the discrimination unit 200, and the alignment correcting unit 220, or in an order of the skew correcting unit 210, the alignment correcting unit 220, and the discrimination unit 200.

A detection operation performed by the discrimination unit 200 is configured by a means of detecting a front end and a rear end of a medium by detectors (not shown) formed of a light-emitting unit and a light-receiving unit disposed at both sides of the returning path 902 to face each other. Thus, a deposited medium is preferably configured to pass through the skew correcting unit 210 before being introduced into the discrimination unit 200. However, since whether the medium is eccentric does not affect the detection operation by the discrimination unit 200, the alignment correcting unit 220 is not required to be positioned in front of the discrimination unit 200 and may be disposed behind the discrimination unit 200.

Based on information detected by the discrimination unit 200, the control unit may distinguish media as a normal medium and a rejected medium, discriminate denominations of the media to control returning paths of the media to follow set paths, and figure out a frequency of use of each type of denomination of media.

The temporary storage unit 300 temporarily stores media identified as normal media by the discrimination unit 200 when the media are deposited or temporarily stores media identified as rejected media by the discrimination unit 200 when the media are withdrawn. Also, when there are media which are not taken and thus returned, or when there is a rejected medium out of media being returned from the banknote storage unit 600, the temporary storage unit 300 may perform a role of temporarily storing the media. The temporary storage unit 300 may include a drum 310 having media wound around an outer circumferential surface thereof and a pair of reels 320 around which a tape 330 is wound to sandwich both surfaces of the media.

When a medium is being stored, the drum 310 rotates in a direction which winds the medium and the tape 330 sandwiching both surfaces of the medium around the outer circumferential surface thereof while the reels 320 rotate in a direction which unwinds the tape 330 that has been wound around the outer circumferential surface thereof.

Conversely, when a medium is being dispensed, the reels 320 rotate in a direction which winds the tape 330 around the outer circumferential surface thereof while the drum 310 rotates in a direction which unwinds the medium and the tape 330 that have been wound around the outer circumferential surface thereof.

By configuring the temporary storage unit 300 by a drum means as above, checks and banknotes may be stored together and media may be promptly processed.

By configuring a single temporary storage unit 300, compared to a case where there are separate temporary storage units for checks and banknotes, an installation space of the temporary storage unit 300 may be reduced and space utilization of the upper module 1 may be improved. In addition, even when denominations of media being dealt with are different and thus the media have various sizes, media of all types of denominations may be temporarily stored together, and thus there is an advantage of being able to simultaneously process media of various denominations.

The printing unit 410 is a component for typing (printing) deposit confirmation information such as a data and an identification number of a check dispensed from the temporary storage unit 300 to be returned toward the check storage unit 400 when the check is being deposited and stored. The printing unit 410 may include a nozzle (not shown) to spray ink and a platen (not shown) disposed at a position facing the nozzle to lift and lower the check.

The check storage unit 400 is a space in which a check that has been temporarily stored in the temporary storage unit 300 is stored by a user's deposit request and is disposed at one side of an inner portion of the upper module 1. When the user requests a deposit, the check that has been temporarily stored in the temporary storage unit 300 is returned to the check storage unit 400 and stored therein after deposit confirmation information is typed on the check by the typing unit 410.

The lost/returned medium storage unit 500 is a space for returning and storing media which are not taken when a user does not take media dispensed from the temporary storage unit 300 and loaded into the withdrawal space 120 of the deposit and withdrawal unit 100 when depositing the media is cancelled or when the user does not take media loaded into the withdrawal space 120 of the deposit and withdrawal unit 100 when the media is withdrawn for a predetermined amount of time. The lost/returned medium storage unit 500 is disposed below the check storage unit 400 at the one side of the inner portion of the upper module 1 such that the check storage unit 400 and the lost/returned medium storage unit 500 are disposed in a vertically stacked structure.

The banknote storage unit 600 stores deposited banknotes therein and separates each sheet of banknotes withdrawn by a withdrawal signal to supply each of the sheets of the banknotes to a returning path 906. The banknote storage unit 600 may include a plurality of first to fourth cassettes 610, 620, 630, and 640 formed to have the same height in order to store banknotes of the same or different denominations, and the fifth cassette 650 and the sixth cassette 660 formed to have a lower height than the first to fourth cassettes 610, 620, 630, and 640, spaced apart from one side of the fourth cassette 640, and installed in a vertically stacked structure.

When dealing with banknotes of different denominations, the first to fourth cassettes 610, 620, 630, and 640 may be configured to have sizes corresponding to a size of a denomination being dealt with and may be set to store banknotes of a denomination with a high frequency of use. The heights of the fifth cassette 650 and the sixth cassette 660 may be configured to be approximately half of the heights of the first to fourth cassettes 610, 620, 630, and 640 and may be set to store banknotes of a denomination with a relatively low frequency of use.

As above, the plurality of cassettes forming the banknote storage unit 600 may be configured in various sizes in consideration of denominations of banknotes and frequencies of use thereof, and small-sized cassettes may be arranged in a vertically stacked structure to enable banknotes to be stored in various storage volumes.

In the present specification, although a case in which the plurality of cassettes arranged in parallel include four cassettes as the first to fourth cassettes 610, 620, 630, and 640 is given as an example, the number of the plurality of cassettes being arranged may of course be different from the above as needed.

The sixth cassette 660 is formed with any one of a depositing/withdrawing cassette 660a in which banknotes to be deposited or withdrawn are stored or an add/return cassette 660b for adding or returning banknotes to the banknote storage unit 600.

The add/return cassette 660b is installed at a space in which the depositing/withdrawing cassette 660a is installed by replacing the depositing/withdrawing cassette 660a when media are added, returned, or calculated and is utilized as a cassette for adding banknotes in the first to fifth cassettes 610, 620, 630, 640, and 650 or storing banknotes returned from the first to fifth cassettes 610, 620, 630, 640, and 650.

The rejected medium storage unit 800 is a space in which banknotes identified as rejected media by the discrimination unit 200 when the banknotes are being withdrawn are returned and stored and is disposed at one side of the fifth cassette 650 and the sixth cassette 660.

The returning path 900 includes a first returning path 901 to connect the deposit space 110 of the deposit and withdrawal unit 100 to an inlet of the discrimination unit 200, a second returning path 902 to connect an outlet of the discrimination unit 200 to the withdrawal space 120 of the deposit and withdrawal unit 100, a third returning path 903 branched from the second returning path 902 to be connected to the temporary storage unit 300, a fourth returning path 904 branched from the second returning path 902 to be connected to the check storage unit 400 and having the typing unit 410 installed on the way, a fifth returning path 905 branched from the second returning path 902 to be connected to the lost/returned medium storage unit 500, a sixth returning path 906 branched from the first returning path 901 disposed at an inlet side of the discrimination unit 200 to be disposed across the upper module 1 and the lower module 2 to connect to the first to fourth cassettes 610, 620, 630, and 640 and the rejected medium storage unit 800, and a seventh returning path 907 branched from the second returning path 902 disposed at an outlet side of the discrimination unit 200 to be disposed across the upper module 1 and the lower module 2 to connect to the sixth returning path 906.

In addition, a gap is provided between the fourth cassette 640, and the fifth cassette 650 and the sixth cassette 660, and in the gap, an eighth returning path 908 branched from the sixth returning path 906 to be connected to the fifth cassette 650, and a ninth returning path 909 branched from the eighth returning path 908 to be connected to the sixth cassette 660 are installed.

One end of the seventh returning path 907 is connected to the second returning path 902 disposed at the outlet side of the discrimination unit 200, and the other end of the seventh returning path 907 is connected to the sixth returning path 906 at a point spaced apart from an upper end of the eighth returning path 908 toward the rear (leftward in the drawings) such that two-way returning of banknotes is possible along the second returning path 902, the seventh returning path 907, and the sixth returning path 906.

As above, by installing the sixth returning path (906, hereinafter, referred to as a first connected returning path) across the upper module 1 and the lower module 2 to connect to the inlet side of the discrimination unit 200 and installing the seventh returning path (907, hereinafter, referred to as a second connected returning path) across the upper module 1 and the lower module 2 to connect to the outlet side of the discrimination unit 200, a path through which a medium is returned between the upper module 1 and the lower module 2 in a process of processing the medium may be shortened and the medium may be efficiently processed to be returned.

A reference numeral G1 represents a first branching point at which the sixth returning path (906, the first connected returning path) branches from the first returning path 901, a reference numeral G2 represents a second branching point at which the seventh returning path (907, the second connected returning path) is branched from the second returning path 902, a reference numeral G3 represents a third branching point at which the fifth returning path 905 is branched from the second returning path 902, a reference numeral G4 represents a fourth branching point at which the fourth returning path 904 is branched from the second returning path 902, a reference numeral G5 represents a fifth branching point at which the third returning path 903 is branched from the second returning path 902, a reference numeral G6 represents a sixth branching point at which the seventh returning path 907 is branched from the sixth returning path 906, a reference numeral G7 represents a seventh branching point at which the eighth returning path 908 is branched from the sixth returning path 906, and a reference numeral G8 represents an eighth branching point at which the ninth returning path 909 is branched from the eighth returning path 908.

Direction-switching gates (not shown) for switching a returning path of a medium are respectively installed at the branching points G1 to G8, and the direction-switching gates are controlled to rotate in a direction following a returning path of a set medium in a process of depositing or withdrawing.

The safe 1000 surrounds the banknote storage unit 600 and the rejected medium storage unit 800 and reinforces an outer wall of the lower module 2 to safely store banknotes stored in the banknote storage unit 600 and the rejected medium storage unit 800 in order to prevent an external intrusion. As described in the related art, the material of the safe 1000 may be configured by coupling a reinforced structure formed of a piece of steel between an inner plate and an outer plate formed of steel, and mixing concrete with a filler such as reinforcing fibers, and pouring and curing the concrete.

In the present disclosure, unlike the related art, due to the check storage unit 400 being installed outside the safe 1000 and the banknote storage unit 600 and the rejected medium storage unit 800 being installed inside the safe 1000, there is an advantage of being able to secure a wide space for storing banknotes inside the safe 1000.

Hereinafter, referring to FIGS. 3 to 5, a depositing process of the medium processing apparatus according to the first embodiment will be described. Arrows in the drawings represent a returning path of media.

FIG. 3 illustrates a returning path of media which are normal media when the media are being deposited and counted. When a user inserts media into the deposit space 110 of the deposit and withdrawal unit 100 for depositing the media, each sheet of the media is separated by the medium dispensing mechanism 101, and the media are returned to the discrimination unit 200 along the first returning path 901. Media which are identified as normal media by the discrimination unit 200 pass through the second returning path 902 and the third returning path 903 to be temporarily stored in the temporary storage unit 300, and the process of depositing and counting ends.

Media identified as rejected media by the discrimination unit 200 are returned along the second returning path 902 to be stored in the withdrawal space 120 of the deposit and withdrawal unit 100 and are received by the user. Then, a process of being rejected from being deposited ends.

When the user requests that depositing be canceled after the process of depositing and counting has ended, media dispensed from the temporary storage unit 300 may pass through the third returning path 903 and the second returning path 902 to be sent to the withdrawal space 120 of the deposit and withdrawal unit 100 in order to be taken by the user.

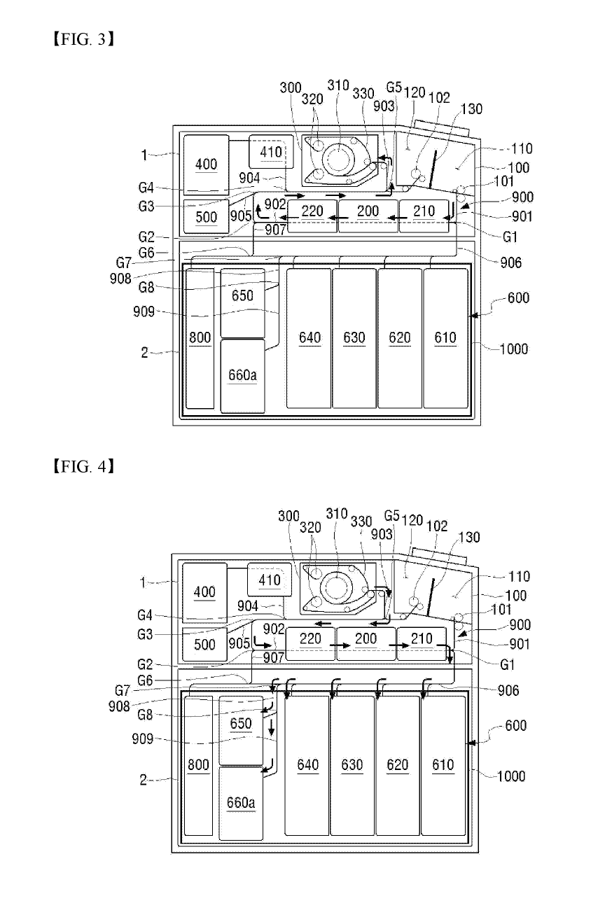

FIG. 4 illustrates a returning path of banknotes which are normal media when the banknotes are being deposited and stored. When a user inputs a deposit confirmation signal while banknotes are temporarily stored in the temporary storage unit 300, the process of depositing and storing proceeds. The banknotes temporarily stored in the temporary storage unit 300 by the process of depositing and counting pass through the third returning path 903 and the second returning path 902 and then pass through the discrimination unit 200 to be stored in the first to fourth cassettes 610, 620, 630, and 640 of the banknote storage unit 600 along the first returning path 901 and the sixth returning path 906, to be stored in the fifth cassette 650 by being branched to the eighth returning path 908 at the seventh branching point G7 of the sixth returning path 906, or to be stored in the sixth cassette 660a by being branched to the ninth returning path 909 at the eighth branching point G8 of the eighth returning path 908.

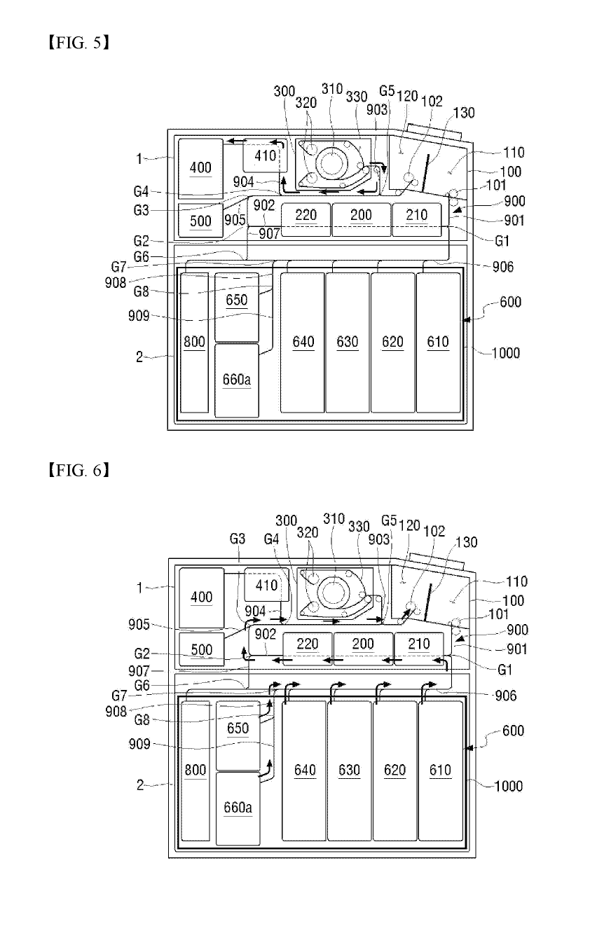

FIG. 5 illustrates a returning path of checks which are normal media when the checks are being deposited and counted. When the user inputs a deposit confirmation signal while checks are temporarily stored in the temporary storage unit 300, the checks temporarily stored in the temporary storage unit 300 by the process of depositing and counting are dispensed to the third returning path 903, returned along the second returning path 902, branched to the fourth returning path 904 at the fourth branching point G4 of the second returning path 902, pass through the typing unit 410, and are then stored in the check storage unit 400.

Of the media temporarily stored in the temporary storage unit 300, media identified as needing to be returned by the discrimination unit 200 are returned from the temporary storage unit 300 along the third returning path 903 and the second returning path 902, pass through the discrimination unit 200, and are returned along the first returning path 901 and the sixth returning path 906 to be stored in the rejected medium storage unit 800.

Hereinafter, referring to FIGS. 6 and 7, a withdrawing process of the medium processing apparatus according to the first embodiment will be described.

FIG. 6 illustrates a returning path of banknotes which are normal media when the banknotes are being withdrawn. When the user requests a withdrawal, banknotes that have been stored in the first to sixth cassettes 610, 620, 630, 640, 650, and 660a are dispensed to be returned to the discrimination unit 200 via the sixth returning path 906 and the first returning path 901, and banknotes identified as normal media by the discrimination unit 200 are sent to the withdrawal space 120 of the deposit and withdrawal unit 100 along the second returning path 902.

FIG. 7 is a returning path of banknotes which are rejected media when the banknotes are being withdrawn. When the user requests a withdrawal, banknotes that have been stored in the banknote storage unit 600 are dispensed to be returned to the discrimination unit 200 via the sixth returning path 906 and the first returning path 901, and banknotes identified as rejected media by the discrimination unit 200 pass through the second returning path 902, the seventh returning path 907, and the sixth returning path 906 to be stored in the rejected medium storage unit 800. As above, in the embodiment, since the sixth branching point G6 at which the seventh returning path 907 and the sixth returning path 906 are connected is disposed rear the seventh branching point G7 at which the eighth returning path 908 and the sixth returning path 906 are connected, banknotes dispensed along the sixth returning path 906 from the first to fourth cassettes 610, 620, 630, an 640 and banknotes dispensed along the sixth returning path 906 from the fifth cassette 650 and the sixth cassette 660a do not interfere with banknotes returned to the rejected medium storage unit 800 through the seventh returning path 907. Thus, there is an advantage of being able to consecutively process banknotes dispensed from the first to sixth cassettes 610, 620, 630, 640, 650, and 660a and reject them from being withdrawn. The withdrawing process ends when loading banknotes to be withdrawn is finished in the deposit and withdrawal unit 100 and the user receives the banknotes.

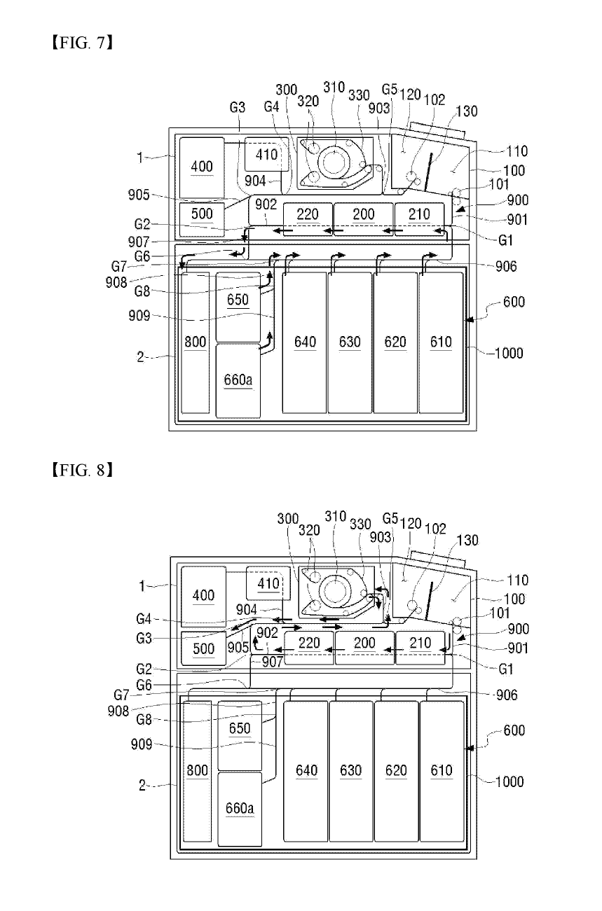

FIG. 8 illustrates a returning path of media when lost media are being returned. A lost return operation is performed when a user does not take banknotes for a predetermined amount of time after loading the banknotes into the withdrawal space 120 of the deposit and withdrawal unit 100 is finished. In this case, the plate 130 of the deposit and withdrawal unit 100 is moved toward the deposit space 110, lost-and-returned media moved toward the deposit space 110 are separated by the medium dispensing mechanism 101 to be temporarily stored in the temporary storage unit 300 via the first returning path 901, the discrimination unit 200, the second returning path 902, and the third returning path 903, then are dispensed from the temporary storage unit 300 to the third returning path 903, and branched at the third branching point G3 of the second returning path 902 in order to be stored in the lost/returned medium storage unit 500.

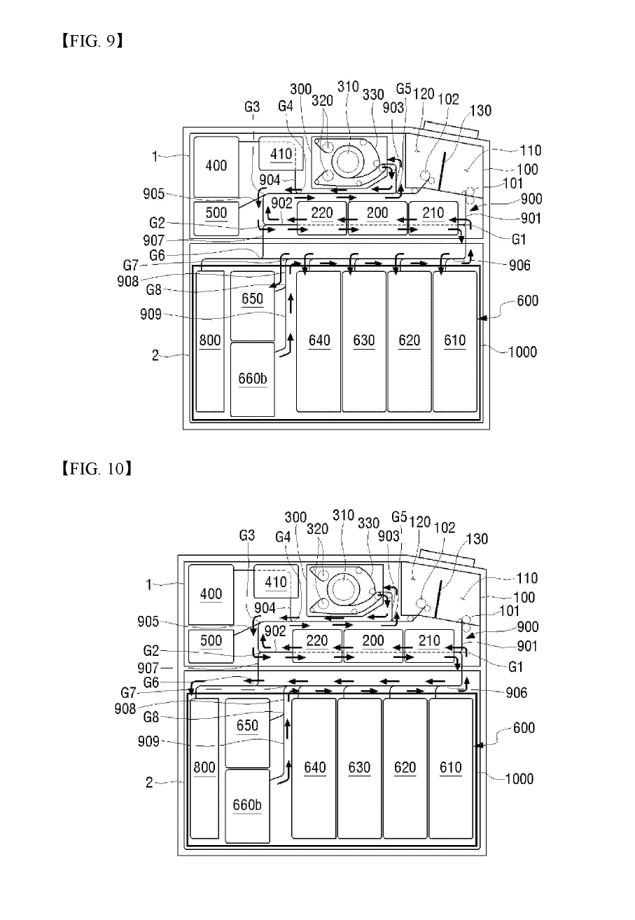

FIG. 9 illustrates a returning path of banknotes which are normal media when the banknotes are being added. When banknotes are being added in the first to fifth cassettes 610, 620, 630, 640, and 650 of the banknote storage unit 600, banknotes dispensed from the add/return cassette 660b are returned to the discrimination unit 200 via the ninth returning path 909, the eighth returning path 908, the sixth returning path 906, and the first returning path 901, and banknotes that have passed through the discrimination unit 200 pass through the second returning path 902 and the third returning path 903 to be temporarily stored in the temporary storage unit 300. The banknotes identified as normal media by the discrimination unit 200 are dispensed from the temporary storage unit 300 and pass through the discrimination unit 200 via the third returning path 903 and the second returning path 902 to be stored in the first to fourth cassettes 610, 620, 630, and 640 along the first returning path 901 and the sixth returning path 906 or to be stored in the fifth cassette 650 by being branched to the eighth returning path 908 at the seventh branching point G7 of the sixth returning path 906.

FIG. 10 illustrates a returning path of banknotes which are rejected media when the banknotes are being added. When banknotes are being added in the first to fifth cassettes 610, 620, 630, 640, and 650 of the banknote storage unit 600, banknotes dispensed from the add/return cassette 660b are returned to the discrimination unit 200 via the ninth returning path 909, the eighth returning path 908, the sixth returning path 906, and the first returning path 901, and banknotes that have passed through the discrimination unit 200 pass through the second returning path 902 and the third returning path 903 to be temporarily stored in the temporary storage unit 300. The banknotes identified as rejected media by the discrimination unit 200 are dispensed from the temporary storage unit 300, pass through the discrimination unit 200 via the third returning path 903 and the second returning path 902, and pass through the first returning path 901 and the sixth returning path 906 to be stored in the rejected medium storage unit 800.

As above, by configuring the add/return cassette 660b to be disposed at a lower portion of the fifth cassette 650 and configuring the seventh branching point G7 at which the ninth returning path 909 and the eighth returning path 908 connected at a front portion of the add/return cassette 660b are connected to the sixth returning path 906 to be disposed in front of the sixth branching point G6 at which the seventh returning path 907 and the sixth returning path 906 are connected, when banknotes are being added in the first to fifth cassettes 610, 620, 630, 640, and 650, the banknotes dispensed from the add/return cassette 660b pass through the discrimination unit 200 to be temporarily stored in the temporary storage unit 300, and according to a result of identification by the discrimination unit 200, normal media are returned to the first to fifth cassettes 610, 620, 630, 640, and 650, and rejected media are returned to the rejected medium storage unit 800.

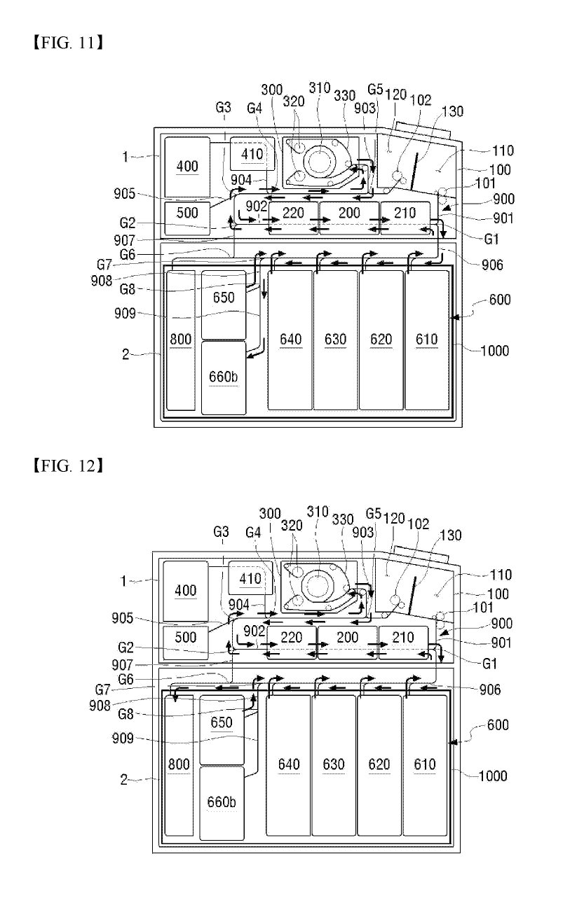

FIG. 11 illustrates a returning path of banknotes which are normal media when the banknotes are being returned. When banknotes stored in the first to fifth cassettes 610, 620, 630, 640, and 650 of the banknote storage unit 600 are being returned, banknotes dispensed from the first to fifth cassettes 610, 620, 630, 640, and 650 are returned to the discrimination unit 200 via the sixth returning path 906 and the first returning path 901, and banknotes that have passed through the discrimination unit 200 pass through the second returning path 902 and the third returning path 903 and are temporarily stored in the temporary storage unit 300. Banknotes identified as normal media by the discrimination unit 200 are dispensed from the temporary storage unit 300, pass through the discrimination unit 200 via the third returning path 903 and the second returning path 902, and are stored in the add/return cassette 660b via the first returning path 901, the sixth returning path 906, the eighth returning path 908, and the ninth returning path 909.

FIG. 12 illustrates a returning path of banknotes which are rejected media when the banknotes are being returned. When banknotes stored in the first to fifth cassettes 610, 620, 630, 640, and 650 of the banknote storage unit 600 are being returned, banknotes dispensed from the first to fifth cassettes 610, 620, 630, 640, and 650 are returned to the discrimination unit 200 via the sixth returning path 906 and the first returning path 901, and banknotes that have passed through the discrimination unit 200 pass through the second returning path 902 and the third returning path 903 and are temporarily stored in the temporary storage unit 300. Banknotes identified as rejected media by the discrimination unit 200 are dispensed from the temporary storage unit 300, pass through the discrimination unit 200 via the third returning path 903 and the second returning path 902, and are stored in the rejected medium storage unit 800 via the first returning path 901 and the sixth returning path 906.

As above, when banknotes are being returned from the first to fifth cassettes 610, 620, 630, 640, and 650, banknotes dispensed from the first to fifth cassettes 610, 620, 630, 640, and 650 pass through the discrimination unit 200 to be temporarily stored to the temporary storage unit 300, and according to a result of identification by the discrimination unit 200, normal media are returned to the add/return cassette 660b, and rejected media are returned to the rejected medium storage unit 800.

As above, according to the first embodiment of the present disclosure, since deposited checks are processed along a returning path disposed inside the upper module 1, a length of a returning path for processing the checks may be configured to be short. In addition, by installing the sixth returning path 906 (the first connected returning path) across the upper module 1 and the lower module 2 to connect to the inlet side of the discrimination unit 200 and installing the seventh returning path 907 (the second connected returning path) across the upper module 1 and the lower module 2 to connect to the outlet side of the discrimination unit 200, a path through which a medium is returned between the upper module 1 and the lower module 2 may be shortened in a process of processing the medium, the medium may be efficiently processed to be returned, and particularly, when banknotes are being withdrawn, banknotes which are rejected media may be consecutively returned without interruption.

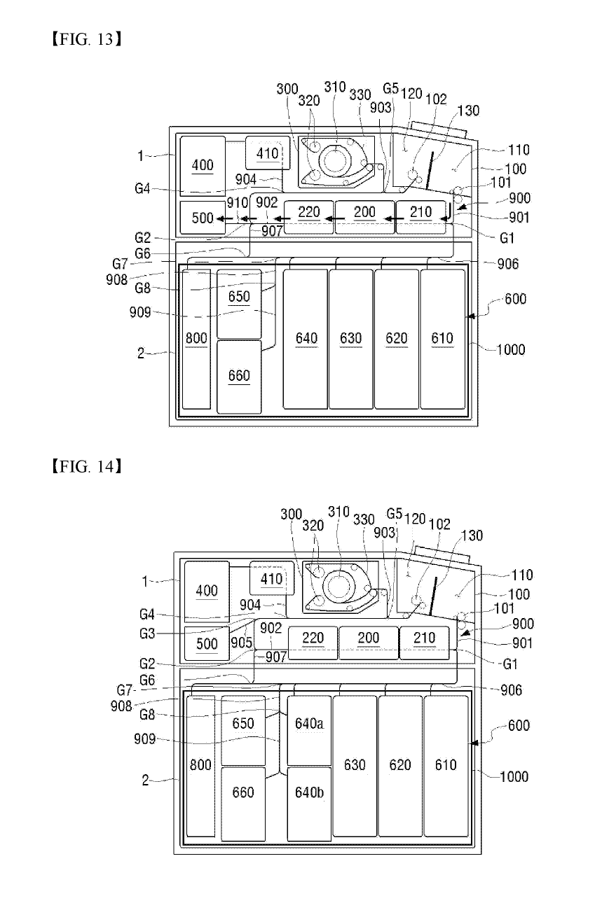

FIG. 13 illustrates a returning path of media when lost media are being returned in a medium processing apparatus according to a second embodiment of the present disclosure. From the configuration of the first embodiment mentioned above, the third branching point G3 and the fifth returning path 905 are not included, and a tenth returning path 910 branched in a direction parallel to the second returning path 902 disposed at the outlet side of the discrimination unit 200 at the branching point G2 at which the second returning path 902 and the seventh returning path 907 are connected and connected to a side of the lost/returned medium storage unit 500 is included. Other configurations are the same as the first embodiment. Consequently, operations in a process of depositing and withdrawing media in the second embodiment may be identically applied as in the first embodiment, and there is a difference in terms of a returning path of banknotes when lost banknotes are returned compared to the first embodiment mentioned above.

Referring to FIG. 13, when lost/returned media are generated, media loaded into the deposit and withdrawal unit 100 are separated by the medium dispensing mechanism 101 and are stored in the lost/returned medium storage unit 500 via the first returning path 901, the discrimination unit 200, the second returning path 902, and the tenth returning path 910.

In this case, at the second branching point G2, a direction-switching gate (not shown) for switching a returning path of media in any one direction of the second returning path 902, the seventh returning path 907, and the tenth returning path 910 is disposed. That is, the direction-switching gate performs a function of switching a returning path of media so that the media may be returned along any one returning path of a first returning path that follows the second returning path 902 that connects the outlet side of the discrimination unit 200 to the deposit and withdrawal unit 100, a second returning path that connects the second returning path 902 at the outlet side of the discrimination unit 200 to the seventh returning path 907, and a third returning path that connects the second returning path 902 at the outlet side of the discrimination unit 200 to the tenth returning path 910. The direction-switching gate may be configured by being selected from various known forms of gates.

As above, according to the second embodiment of the present disclosure, when lost/returned media are generated, a structure of a returning path that connects from the deposit and withdrawal unit 100 to the lost/returned medium storage unit 500 may be simplified.

Meanwhile, in the first embodiment and the second embodiment, an adding operation and a returning operation may be repeated for each cassette of the first to fifth cassettes 610, 620, 630, 640, and 650 to perform calculation of banknotes.

FIG. 14 is a block diagram of a medium processing apparatus according to a third embodiment of the present disclosure.

All configurations of the medium processing apparatus of the third embodiment are the same as those of the medium processing apparatus of the first embodiment, but there is a difference from the first embodiment that the fourth cassette 640 is formed of an upper cassette 640a and a lower cassette 640b installed in a vertically stacked structure.

The upper cassette 640a and the lower cassette 640b are formed at a lower height than those of the first to third cassettes 610, 620, and 630. The upper cassette 640a is installed to face the fifth cassette 650 while having the eighth returning path 908 and the ninth returning path 909 therebetween, and the lower cassette 640b is installed to face the sixth cassette 660 while having the ninth returning path 909 therebetween.

As described above, the present disclosure is not limited to the embodiments mentioned above, and self-evident modifications and practices are possible by those of ordinary skill in the art to which the present disclosure pertains without departing from the technical spirit of the present disclosure claimed in the claims, and the modifications and practices belong to the scope of the present disclosure.

### INDUSTRIAL APPLICABILITY

By configuring spaces in which checks and banknotes are stored to be spatially separated as an upper portion and a lower portion in a medium processing apparatus, the present disclosure shortens a length of a returning path of the checks to efficiently process media. Thus, the present disclosure has industrial applicability.

1. A medium processing apparatus for processing media consisting of banknotes and checks to be deposited or withdrawn, the medium processing apparatus comprising:
a deposit and withdrawal unit (100) having a space for inserting or receiving the media when the media are being deposited or withdrawn;
a discrimination unit (200) configured to discriminate an abnormality and a denomination of the media;
a temporary storage unit (300) configured to temporarily store media that have passed through the discrimination unit (200);
a check storage unit (400) configured to store the checks;
a banknote storage unit (600) formed of a plurality of cassettes (610, 620, 630, 640, 650, 660) to store the banknotes;
a rejected medium storage unit (800) configured to store media rejected by the discrimination unit (200); and
a returning path (900) configured to return the media, wherein:
the deposit and withdrawal unit (100), the discrimination unit (200), the temporary storage unit (300), and the check storage unit (400) are disposed in an upper module (1); and
the banknote storage unit (600) is disposed in a lower module (2) installed below the upper module (1).

2. The medium processing apparatus of claim 1, wherein:
a returning path configured to connect the deposit and withdrawal unit (100) to the check storage unit (400) is disposed in the upper module (1); and
a returning path configured to connect the deposit and withdrawal unit (100) to the banknote storage unit (600) is disposed across the upper module (1) and the lower module (2).

3. The medium processing apparatus of claim 2, wherein:
a first connected returning path connected to the banknote storage unit (600) across the upper module (1) and the lower module (2) is disposed at an inlet side of the discrimination unit (200); and
a second connected returning path connected to the first connected returning path across the upper module (1) and the lower module (2) is disposed at an outlet side of the discrimination unit (200).

4. The medium processing apparatus of claim 3, wherein the returning path (900) includes:
a first returning path (901) configured to connect the deposit space (110) of the deposit and withdrawal unit (100) to an inlet of the discrimination unit (200);
a second returning path (902) configured to connect an outlet of the discrimination unit (200) to the withdrawal space (120) of the deposit and withdrawal unit (100);
a third returning path (903) branched from the second returning path (902) to be connected to the temporary storage unit (300);
a fourth returning path (904) branched from the second returning path (902) to be connected to the check storage unit (400);
a sixth returning path (906) branched from the first returning path (901) disposed at the inlet side of the discrimination unit (200) to form the first connected returning path; and
a seventh returning path (907) branched from the second returning path (902) disposed at the outlet side of the discrimination unit (200) to form the second connected returning path.

5. The medium processing apparatus of claim 4, wherein:
the plurality of cassettes (610, 620,630, 640, 650, 660) include cassettes (610, 620, 630) of a same height installed in parallel in a transverse direction, a fifth cassette (650) and a sixth cassette (660) formed at a lower height than those of the cassettes (610, 620, 630) and installed in a vertically stacked structure, and a fourth cassette (640) installed between the cassettes (610, 620, 630) of the same height and the fifth cassette (650) and the sixth cassette (660) while being installed to be spaced apart from the fifth cassette (650) and the sixth cassette (660);
the rejected medium storage unit (800) is installed at one side of the fifth cassette (650) and the sixth cassette (660);
the sixth returning path (906) is connected to the cassettes (610, 620, 630) of the same height, the fourth cassette (640), and the rejected medium storage unit (800); and
in a gap between the fourth cassette (640) and the fifth cassette (650) and the sixth cassette (660), an eighth returning path (908) branched from the sixth returning path (906) to be connected to the fifth cassette (650) and a ninth returning path (909) branched from the eighth returning path (908) to be connected to the sixth cassette (660) are installed.

6. The medium processing apparatus of claim 5, wherein:
one end of the seventh returning path (907) is connected to the second returning path (902) disposed at the outlet side of the discrimination unit (200);
the other end of the seventh returning path (907) is connected to the sixth returning path (906) at a point spaced apart toward a rear at a branching point at which the sixth returning path (906) and the eighth returning path 908 are connected; and
interference between banknotes returned through the eighth returning path (908) and the sixth returning path (906) and banknotes returned through the seventh returning path (907) and the sixth returning path (906) is prevented.

7. The medium processing apparatus of claim 6, wherein, when banknotes loaded into the banknote storage unit (600) are being withdrawn:
banknotes dispensed from the cassettes (610, 620, 630) of the same height and the fourth cassette (640) are returned to the discrimination unit (200) along the sixth returning path (906) and the first returning path (901), and banknotes dispensed from the fifth cassette (650) are returned to the discrimination unit (200) along the eighth returning path (908), the sixth returning path (906) and the first returning path (901); and
banknotes identified as rejected media by the discrimination unit (200) are returned to the rejected medium storage unit (800) along the second returning path (902), the seventh returning path (907), and the sixth returning path (906).

8. The medium processing apparatus of claim 4, wherein:
a lost/returned medium storage unit (500) is disposed in a vertically stacked structure with the check storage unit (400) in the upper module (1); and
the returning path (900) further includes a fifth returning path (905) connecting from the second returning path (902) to a side of the lost/returned medium storage unit (500) to return media dispensed from the temporary storage unit (300) to the lost/returned medium storage unit (500).

9. The medium processing apparatus of claim 4, wherein:
a lost/returned medium storage unit (500) is disposed in a vertically stacked structure with the check storage unit (400) in the upper module (1);
the returning path (900) includes a tenth returning path (910) branched at a branching point (G2) at which the second returning path (902) and the seventh returning path (907) are branched in a direction parallel to the second returning path (902) disposed at the outlet side of the discrimination unit (200) and connected to a side of the lost/returned medium storage unit (500); and
at the branching point (G2), a direction-switching gate for switching a returning path of media in any one direction of the second returning path (902), the seventh returning path (907), and the tenth returning path (910) is disposed.

10. The medium processing apparatus of claim 1, wherein the banknote storage unit (600) and the rejected medium storage unit (800) are disposed inside a safe (1000), and the check storage unit (400) is disposed outside the safe (1000).

11. The medium processing apparatus of claim 1, wherein:
an add/return cassette (660b) for adding or returning banknotes is included in the banknote storage unit (600); and
when banknotes in the add/return cassette (660b) are added to remaining cassettes (610, 620, 630, 640, 650) of the banknote storage unit 600 or when banknotes in the remaining cassettes (610, 620, 630, 640, 650) are returned to the add/return cassette (660b), the banknotes pass through the temporary storage unit (300).

12. The medium processing apparatus of claim 11, wherein:
when banknotes are added to the remaining cassettes (610, 620, 630, 640, 650), banknotes dispensed from the add/return cassette (660b) pass through the discrimination unit (200) and are then returned to the temporary storage unit (300);
banknotes identified as normal media by the discrimination unit (200) are dispensed from the temporary storage unit (300), pass through the discrimination unit (200), and are then returned to the remaining cassettes (610, 620, 630, 640, 650); and
banknotes identified as rejected media by the discrimination unit (200) are dispensed from the temporary storage unit (300), pass through the discrimination unit (200), and are then returned to the rejected medium storage unit (800).

13. The medium processing apparatus of claim 12, wherein:
the returning path (900) includes a first returning path (901) configured to connect the deposit space (110) of the deposit and withdrawal unit (100) to an inlet of the discrimination unit (200), a second returning path (902) configured to connect an outlet of the discrimination unit (200) to the withdrawal space (120) of the deposit and withdrawal unit (100), a third returning path (903) branched from the second returning path (902) to be connected to the temporary storage unit (300), a fourth returning path (904) branched from the second returning path (902) to be connected to the check storage unit (400), a sixth returning path (906) branched from the first returning path (901) disposed at an inlet side of the discrimination unit (200) across the upper module (1) and the lower module (2) to form a first connected returning path connected to the banknote storage unit (600), and a seventh returning path (907) branched from the second returning path (902) disposed at an outlet side of the discrimination unit (200) across the upper module (1) and the lower module (2) to form a second connected returning path connected to the first connected returning path;
banknotes identified as normal media by the discrimination unit (200) are dispensed from the temporary storage unit (300), pass through the discrimination unit (200) along the third returning path (903) and the second returning path (902), and are then returned to the remaining cassettes (610, 620, 630, 640, 650) along the first returning path (901) and the sixth returning path (906); and
banknotes identified as rejected media by the discrimination unit (200) are dispensed from the temporary storage unit (300), pass through the discrimination unit (200) along the third returning path (903) and the second returning path (902), and are then returned to the rejected medium storage unit (800) along the first returning path (901) and the sixth returning path (906).

14. The medium processing apparatus of claim 11, wherein, when banknotes loaded into the remaining cassettes (610, 620, 630, 640, 650) are being returned:
banknotes dispensed from the remaining cassettes (610, 620, 630, 640, 650) pass through the discrimination unit (200) and are then returned to the temporary storage unit (300);
banknotes identified as normal media by the discrimination unit (200) are dispensed from the temporary storage unit (300), pass through the discrimination unit (200), and are then returned to the add/return cassette (660b); and
banknotes identified as rejected media by the discrimination unit (200) are dispensed from the temporary storage unit (300), pass through the discrimination unit (200), and are then returned to the rejected medium storage unit (800).

15. The medium processing apparatus of claim 14, wherein:
the remaining cassettes (610, 620,630, 640, 650) include cassettes (610, 620, 630) of a same height installed in parallel in a transverse direction, a fifth cassette (650) and a sixth cassette (660) formed at a lower height than those of the cassettes (610, 620, 630) and installed in a vertically stacked structure, and a fourth cassette (640) installed between the cassettes (610, 620, 630) of the same height and the fifth cassette (650) and the sixth cassette (660) while being installed to be spaced apart from the fifth cassette (650) and the sixth cassette (660);
the returning path (900) includes a first returning path (901) configured to connect the deposit space (110) of the deposit and withdrawal unit (100) to an inlet of the discrimination unit (200), a second returning path (902) configured to connect an outlet of the discrimination unit (200) to the withdrawal space (120) of the deposit and withdrawal unit (100), a third returning path (903) branched from the second returning path (902) to be connected to the temporary storage unit (300), a fourth returning path (904) branched from the second returning path (902) to be connected to the check storage unit (400), a sixth returning path (906) branched from the first returning path (901) disposed at the inlet side of the discrimination unit (200) across the upper module (1) and the lower module (2) to form a first connected returning path connected to the banknote storage unit (600), a seventh returning path (907) branched from the second returning path (902) disposed at the outlet side of the discrimination unit (200) across the upper module (1) and the lower module (2) to form a second connected returning path connected to the first connected returning path, an eighth returning path (908) branched from the sixth returning path (906) to be connected to the fifth cassette (650), and a ninth returning path (909) branched from the eighth returning path (908) to be connected to the sixth cassette (660);
banknotes dispensed from the cassettes (610, 620, 630) of the same height and the fourth cassette (640) are returned to the discrimination unit (200) along the sixth returning path (906) and the first returning path (901), banknotes dispensed from the fifth cassette (650) are returned to the discrimination unit (200) along the eighth returning path (908), the sixth returning path (906) and the first returning path (901), and banknotes that have passed through the discrimination unit (200) are returned to the temporary storage unit (300) along the second returning path (902) and the third returning path (903);
banknotes identified as normal media by the discrimination unit (200) are dispensed from the temporary storage unit (300), pass through the discrimination unit (200) along the third returning path (903) and the second returning path (902), and are then returned to the add/return cassette (660b) along the first returning path (901), the sixth returning path (906), the eighth returning path (908), and the ninth returning path (909); and
banknotes identified as rejected media by the discrimination unit (200) are dispensed from the temporary storage unit (300), pass through the discrimination unit (200) along the third returning path (903) and the second returning path (902), and are then returned to the rejected medium storage unit (800) along the first returning path (901) and the sixth returning path (906).

16. The medium processing apparatus of claim 1, wherein a sixth cassette (660) is formed with any one of a depositing/withdrawing cassette (660a) in which banknotes to be deposited or withdrawn are stored or an add/return cassette (660b) for adding or returning banknotes to the banknote storage unit (600), and the depositing/withdrawing cassette (660a) and the add/return cassette (660b) are replaceably installed.
